(19) United States
(12) Patent Application Publication
(10) Pub. No.: US 2009/0231259 A1
(43) Pub. Date: Sep. 17, 2009

(54) APPARATUS AND METHOD FOR ELIMINATING IMAGE STICKING OF LIQUID CRYSTAL DISPLAY

(75) Inventors: Chun-Chieh Yu, Taipei City (TW); Shin-Chung Huang, Taipei County (TW); I-Cheng Chen, Changhua County (TW)

Correspondence Address: J C PATENTS, INC., 4 VENTURE, SUITE 250, IRVINE, CA, 92618, US

(73) Assignee: CHUNGHWA PICTURE TUBES, LTD., Taoyuan (TW)

(21) Appl. No.: 12/365,530

(22) Filed: Feb. 4, 2009

(30) Foreign Application Priority Data
Mar. 12, 2008 (TW) 97108691

(51) Int. Cl. G09G 3/36

(52) U.S. Cl. 345/92

(57) ABSTRACT

An apparatus and a method for eliminating an image sticking of a liquid crystal display (LCD) are provided. The image sticking occurs when the LCD is turned off. The LCD includes a data driver and a number of pixels coupled to a common voltage. The apparatus includes a voltage detector and a voltage switching device. The voltage detector detects a system voltage of the LCD and outputs a control signal according to the system voltage. The voltage switching device is coupled to the voltage detector for selectively providing a data voltage or the common voltage as a driving voltage of the data driver according to the control signal. The voltage switching device is controlled by the control signal to provide the common voltage to the data driver when the system voltage is less than a reference voltage.

### CROSS-REFERENCE TO RELATED APPLICATION

This application claims the priority benefit of Taiwan application serial no. 97108691, filed Mar. 12, 2008. The entirety of the above-mentioned patent application is hereby incorporated by reference herein and made a part of this specification.

### BACKGROUND OF THE INVENTION

1. Field of the Invention

The present invention relates to an apparatus and a method for eliminating an image sticking of a liquid crystal display (LCD) when the LCD is turned off, and more particularly, to a method and an apparatus that provide a common voltage as a driving voltage of a data driver for eliminating an image sticking of an LCD when the LCD is turned off.

2. Description of Related Art

As optoelectronic and semiconductor technologies advance, thin film transistor liquid crystal displays (TFT-LCDs) with advantages of great space utilization efficiency, low power consumption, free radiation, and low electrical field interference have become the mainstream in the display device market. The TFT-LCDs have been widely applied to electronic products closely relevant to our daily lives, such as laptop computers, mobile phones, televisions, and so forth. Therefore, research efforts aiming to improve a display quality of the TFT-LCDs have been continuously made.

The TFT-LCD has no capacity of emitting light by itself so that a backlight module providing a light source is normally disposed within the TFT-LCD. FIG. 1 is a schematic circuit diagram of a TFT-LCD. Referring to FIG. 1, a TFT-LCD 100 includes a scan driver 101, a data driver 105, and a plurality of pixel units 104. Each of the pixel units 104 includes a TFT 106, a liquid crystal capacitor 107, and a storage capacitor 108. The liquid crystal capacitor 107 and the storage capacitor 108 are commonly coupled to a common voltage Vcom.

As the TFT-LCD 100 displays frames, the scan driver 101 turns on scan lines 102 in sequence, such that the TFTs 106 on the same scan line 102 are conducted. In the meantime, the data driver 105 converts video signals into data driving voltages and output the data driving voltages to data lines 103. Thereby, the liquid crystal capacitors 107 and the storage capacitors 108 on the turn-on scan lines 102 can receive and store the data driving voltages through the data lines 103, such that the frame can be retained until the frame is updated to the next frame.

However, when the TFT-LCD 100 is turned off, electrical charges stored in the liquid crystal capacitors 107 and the storage capacitors 108 should be released after a period of time. Here, the residual charges may make an impact on the TFT-LCD 100, such that liquid crystals disposed on a panel of the TFT-LCD 100 are rotated. At this time, a problem of an image sticking often occurs if the backlight is not completely off. To solve said problem of the image sticking, a reset circuit is disposed in the TFT-LCD 100 according to the pertinent art. At the moment that the TFT-LCD 100 is turned off, the scan driver 101 is controlled by the reset circuit for conducting all the TFTs 106 on each of the scan lines 102. As such, the liquid crystal capacitors 107 and the storage capacitors 108 are discharged to the data lines 103 through the conducted TFTs 106, so as to reduce the time during which the image sticking occurs.

Nevertheless, said solution still has the following drawbacks:
1. The conducted TFTs 106 return to a semi-conductive state after a short period of time, and thus a speed of discharging the charges is significantly reduced.
2. Not all of the panels have the common voltages Vcom set as a ground voltage. As the common voltage Vcom is half of a voltage VDD, a relatively long period of time is required for discharging the common voltage to the ground voltage. The unstable voltage difference has an influence on the liquid crystal capacitors 107 and the storage capacitors 108, and results in the rotation of the liquid crystals, thus giving rise to the image sticking.

Hence, how to effectively eliminate the image sticking of the LCD when the LCD is turned off has become one of the most important issues at this current stage.

### SUMMARY OF THE INVENTION

The present invention is directed to an apparatus and a method for eliminating an image sticking of an LCD when the LCD is turned off, so as to accelerate a discharging speed of residual charges and prevent a panel of the LCD from being affected by an unstable voltage difference. Thereby, the image sticking of the LCD can be avoided when the LCD is turned off.

The present invention provides an apparatus for eliminating an image sticking of an LCD when the LCD is turned off. The LCD includes a data driver and a plurality of pixels coupled to a common voltage. Said apparatus includes a voltage detector and a voltage switching device. The voltage detector detects a system voltage used to operate the LCD and outputs a control signal according to the system voltage. The voltage switching device is coupled to the voltage detector for selectively providing a data voltage or the common voltage as a driving voltage of the data driver according to the control signal. The voltage switching device is controlled by the control signal to provide the common voltage to the data driver when the system voltage is less than a reference voltage.

The present invention further provides a method for eliminating an image sticking of an LCD when the LCD is turned off. The LCD includes a data driver and a plurality of pixels coupled to a common voltage. In the method, a system voltage for operating the LCD is first detected. Next, the common voltage is provided as a driving voltage of the data driver when the system voltage is less than a reference voltage.

The present invention provides the common voltage serving as the driving voltage to the data driver when the LCD is detected to have been turned off. Here, the pixels are collectively coupled to the common voltage. At the moment that the LCD is turned off, an electrical field for controlling a rotation of liquid crystals is reduced to the lowest extent, and the residual charges in the storage capacitor are minimized. As such, discharging the residual charges can be expedited, and the image sticking of the LCD can be avoided when the LCD is turned off.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a TFT-LCD.

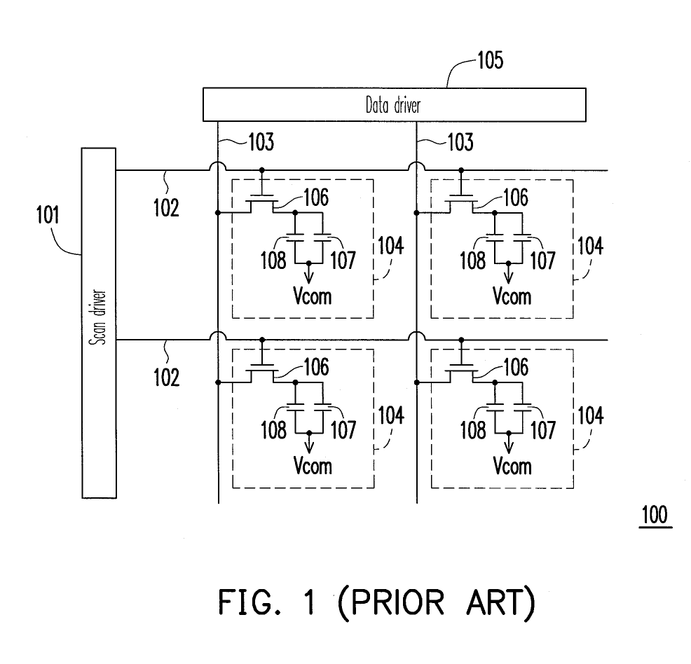

FIG. 2 is a circuit diagram of a display apparatus according to an embodiment of the present invention.

FIG. 3 is a flowchart illustrating a method for eliminating an image sticking of a display apparatus when the display apparatus is turned off according to an embodiment of the present invention.

### DESCRIPTION OF EMBODIMENTS

In general, storage capacitors and liquid crystal capacitors in an LCD are used to store charges, such that a frame can be retained until the frame is updated to the next frame. As the LCD is turned off, a period of time is required for completely releasing the stored charges, and thus the residual charges may result in an image sticking on a panel of the LCD. On the other hand, at the moment that the LCD is turned off, a common voltage coupled to both the storage capacitors and the liquid crystal capacitors may give rise to the image sticking on the panel of the LCD due to an unstable voltage, difference. In light of the foregoing, the present invention is exemplified for resolving the issue of the image sticking of the LCD when the LCD is turned off. Before the present invention is elaborated by the following embodiments, it is first assumed that a display apparatus discussed herein is a transmissive LCD.

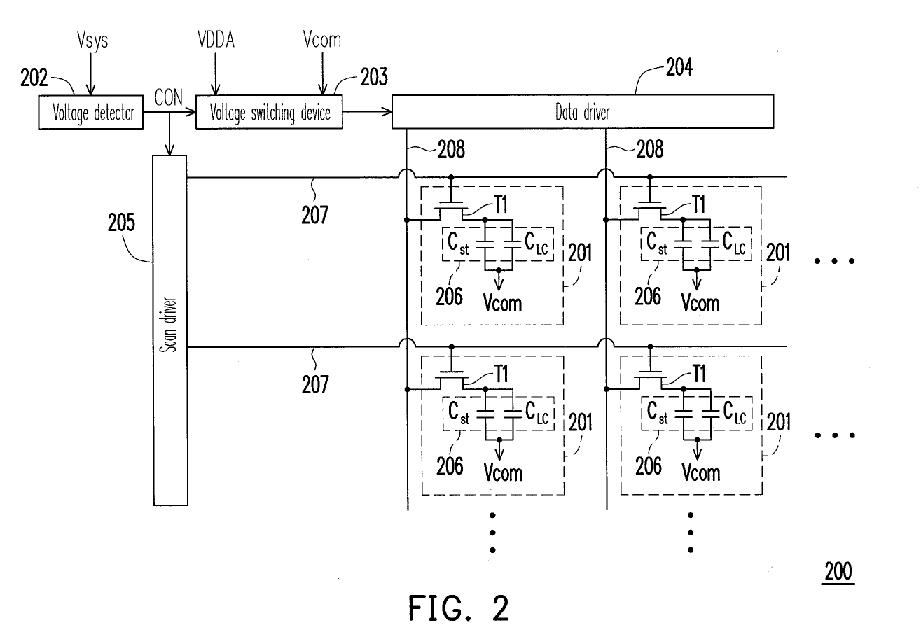

FIG. 2 is a schematic circuit diagram of a display apparatus according to an embodiment of the present invention. Referring to FIG. 2, a display apparatus 200 includes a plurality of pixels 201, a voltage detector 202, a voltage switching device 203, a data driver 204, and a scan driver 205. Each of the pixels 201 includes a TFT T1 and a capacitor unit 206 composed of a liquid crystal capacitor C_{LC} and a storage capacitor Cₛₜ.

The voltage detector 202 detects a system voltage Vsys, which is used to operate the display apparatus 200, and outputs a control signal CON according to a comparison result of the system voltage Vsys and a reference voltage. The voltage switching device 203 is coupled to the voltage detector 202 for selectively providing a data voltage VDDA or the common voltage Vcom to the data driver 204 according to the control signal CON. The data driver 204 is coupled between the voltage switching device 203 and the pixels 201 for receiving the common voltage Vcom or the data voltage VDDA that is provided by the voltage switching device 203 as a driving voltage of the pixels 201. In addition, a gate of the TFT T1 and a first source/drain of the TFT T1 are coupled to the scan driver 205 and the data driver 204 through scan lines 207 and data lines 208, respectively. The liquid crystal capacitor C_{LC} and the storage capacitor Cₛₜ of the capacitor unit 206 are coupled between a second source/drain of the TFT T1 and the common voltage Vcom.

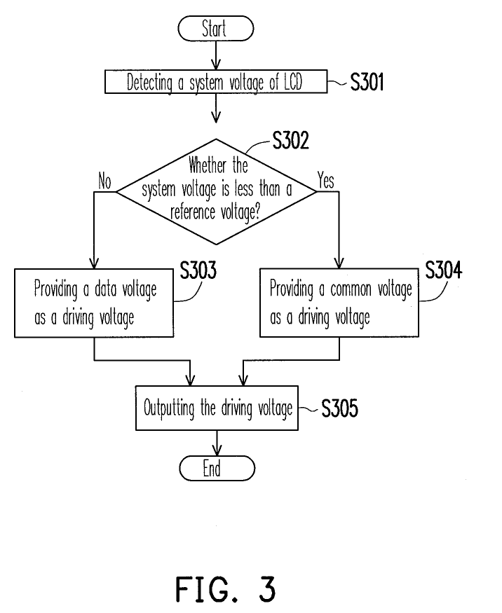

FIG. 3 is a flowchart illustrating a method for eliminating an image sticking of a display apparatus when the display apparatus is turned off according to an embodiment of the present invention. Referring to FIG. 3, the voltage detector 202 first detects the system voltage Vsys used for operating the display apparatus 200 in step S301 and then determines if the system voltage Vsys is less than a reference voltage in step S302.

When the system voltage Vsys is not less than the reference voltage, the voltage switching device 203 is controlled by the control signal CON for providing the data voltage VDDA to the data driver 204 in step S303. Therefore, the data driver 204 outputs the data voltage VDDA as the driving voltage for driving the pixels 201 in step S305. At this time, the data driver 204 is operated as usual and displays frames in a normal manner.

On the contrary, when the system voltage Vsys is less than the reference voltage, i.e., the voltage detector 202 detects that the display apparatus 200 is turned off, the voltage switching device 203 is controlled by the control signal CON to provide the common voltage Vcom to the data driver 204 in step S304. Therefore, the data driver 204 outputs the common voltage Vcom as the driving voltage for driving the pixels 201 in step S305.

It is noted that a voltage difference causing a rotation of liquid crystals is equal to the driving voltage subtracting the common voltage Vcom. As the driving voltage output by the data driver 204 is the common voltage Vcom, the voltage difference between the liquid crystal capacitor C_{LC} and the storage capacitor Cₛₜ is zero theoretically, and thus the liquid crystals are not rotated and no frame is displayed by the panel. Practically, when the common voltage Vcom is provided as the driving voltage, the residual charges in the capacitor unit 206 are minimized. Accordingly, when the display apparatus 200 is turned off, not only the panel is not affected by the unstable voltage difference, but also discharging the residual charges stored in the capacitor unit 206 is accelerated. The image sticking of the display apparatus 200 is further avoided when the LCD is turned off.

In addition, when the system voltage Vsys is less than the reference voltage, the scan driver 205 is also controlled by the control signal CON to generate a plurality of driving signals at a logic-high level and transmit the driving signals to the TFT T1 in each of the pixels 201 through the corresponding scan line 207, such that the TFTs T1 are conducted. At this time, each of the pixels 201 are turned on and a discharge path is formed for expediting the discharging operation performed on the residual charges in the capacitor unit 206.

In summary, when the LCD is detected to have been turned off, the data voltage inputted to the data driver is switched to the common voltage according to the embodiments of the present invention, such that the data driver can output the voltage level of the common voltage to the pixels in the panel. Since the pixels are coupled to the common voltage, the voltage across the capacitor unit 206, which controls the rotation of the liquid crystals, is reduced to the greatest extent at the moment that the LCD is turned off. Besides, the residual charges in the liquid crystal capacitors and the storage capacitors are minimized. As such, the speed of discharging the residual charges can be relatively increased when the LCD is turned off. In conclusion, the above embodiments of the present invention are provided to significantly reduce the image sticking of the LCD when the LCD is turned off.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for eliminating an image sticking of a liquid crystal display (LCD) when the LCD is turned off, the LCD comprising a data driver and a plurality of pixels coupled to a common voltage, the apparatus comprising:
a voltage detector, detecting a system voltage used to operate the LCD and outputting a control signal; and
a voltage switching device, coupled to the voltage detector for selectively providing a data voltage or the common voltage as a driving voltage of the data driver according to the control signal,
wherein when the system voltage is less than a reference voltage, the voltage switching device is controlled by the control signal to provide the common voltage to the data driver.

2. The apparatus as claimed in claim 1, wherein the voltage detector is further coupled to a scan driver, and the scan driver is controlled by the control signal for generating a plurality of driving signals to the pixels when the system voltage is less than the reference voltage, so as to turn on the pixels and form a discharge path.

3. The apparatus as claimed in claim 2, wherein each of the pixels comprises:
a thin film transistor (TFT), comprising a gate, a first source/drain, and a second source/drain, the gate being coupled to the scan driver, the first source/drain being coupled to the data driver;
a storage capacitor, an end of the storage capacitor being coupled to the second source/drain of the TFT, the other end of the storage capacitor being coupled to the common voltage; and
a liquid crystal capacitor, an end of the liquid crystal capacitor being coupled to the second source/drain of the TFT, the other end of the liquid crystal capacitor being coupled to the common voltage.

4. A method for eliminating an image sticking of a liquid crystal display (LCD) when the LCD is turned off, the LCD comprising a data driver and a plurality of pixels coupled to a common voltage, the method comprising:
detecting a system voltage used to operate the LCD; and
providing the common voltage as a driving voltage of the data driver when the system voltage is less than a reference voltage.

5. The method as claimed in claim 4, wherein a scan driver of the LCD is controlled for generating a plurality of driving signals to the pixels when the system voltage is less than the reference voltage, so as to turn on the pixels and form a discharge path.
